(19) United States
(12) Patent Application Publication
(10) Pub. No.: US 2024/0105966 A1
(43) Pub. Date: Mar. 28, 2024

(54) METHOD OF COATING BIPOLAR PLATES AND BIPOLAR PLATE

(71) Applicant: CELLCENTRIC GMBH & CO. KG, Kirchheim/Teck-Nabern (DE)

(72) Inventors: Marc-Vincent MÜLLER, Kirchheim/Teck-Nabern (DE); Philipp HAUSMANN, Kirchheim/Teck-Nabern (DE)

(21) Appl. No.: 18/264,030

(22) PCT Filed: Feb. 14, 2022
(86) PCT No.: PCT/EP2022/053451

§ 371 Date: Aug. 2, 2023

(30) Foreign Application Priority Data
Feb. 15, 2021 (DE) 10 2021 000 763.8

(51) Int. Cl. H01M 8/0221; H01M 8/0226; H01M 8/0228; H01M 8/026; H01M 8/0263

(52) U.S. Cl. CPC H01M 8/0221; H01M 8/0226; H01M 8/0228; H01M 8/026; H01M 8/0263; H01M 2250/20

(57) ABSTRACT

The invention relates to a method for coating bipolar plates. It is characterized by at least the following method steps:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma.

The invention relates to a method for coating bipolar plates, a bipolar plate, a fuel cell and a vehicle.

Bipolar plates are central components of fuel cell stacks, also known as stacks. As an integral assembly, bipolar plates fulfill the following functions: producing an electrically conductive connection between an anode of a first cell in the fuel cell stack and a cathode in a second cell in the fuel cell stack that is adjacent to the first cell, supplying and distributing reaction gases into the reaction zone of a cell in the fuel cell stack, discharging resulting reaction products such as liquid or gaseous water, as well as absorption or release of thermal energy. In order to supply the reaction gases and to discharge the reaction products, flow profiles such as flow channels are typically applied to a bipolar plate, for example by milling or pressing-in. Furthermore, a bipolar plate can have cooling channels in its interior, through which a cooling medium is conveyed for removing dissipated heat. The plate is often assembled from two halves placed back to back.

Typically, metallic bipolar plates are coated to increase their electrical conductivity and thus to increase the electrical power output by a fuel cell. The chemical resistance of the bipolar plate is also increased with the help of the coating in order to protect it from corrosion. Such coatings are mostly applied with the so-called physical vapor deposition process (PVD). This requires the creation of a vacuum. In addition, the bipolar plates are exposed to high thermal stress. The production of such coatings is therefore comparatively expensive and complex.

The present invention is based on the object of specifying a method for coating bipolar plates, with the aid of which bipolar plates can be coated more simply and cost-effectively with a comparatively high level of process reliability. A further object of the present invention is to specify a bipolar plate coated with such a method.

According to the invention, these objects are achieved by a method for coating bipolar plates having the features of claim 1 and a bipolar plate having the features of claim 6. Advantageous embodiments and developments as well as a fuel cell with such a bipolar plate and a vehicle with such a fuel cell result from the dependent claims.

In a method for coating bipolar plates, at least the following steps are carried out according to the invention:
applying an epoxy resin-carbon mixture at least to regions of at least one side to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma.

The method according to the invention allows bipolar plates to be coated in a particularly process-reliable, simple and cost-effective manner. The coating in the form of the epoxy resin-carbon mixture can be applied to a bipolar plate like a paint. It is not necessary to create a vacuum or subject the bipolar plate to high thermal stress, as is the case with the PVD process. The epoxy resin provides a protective layer to protect the bipolar plates from corrosion. Conductivity of the coating can be ensured with the aid of the added carbon. The hydrophilization by means of the low-pressure plasma changes a chemical structure of the surface of the coating, so that polar functional groups are built into the coating. This ensures conductivity of the surface of the coating and also improves the wettability and adhesion of moisture on the coated surface. The low-pressure plasma can already be generated at room temperature, which enables careful but effective surface treatment. According to the method according to the invention, only the roughened regions of the epoxy resin-carbon mixture coating are rendered hydrophilic. Not surface-treated regions of the coating remain in their untreated state and therefore have hydrophobic properties due to the epoxy resin. Thus, there are partial regions with hydrophilic properties and partial regions with hydrophobic properties on the final coated bipolar plate. This makes it possible to drain product water that is produced in a targeted manner and to enable an improved gas flow on the bipolar plate. This makes it possible to increase the electrical power output by individual fuel cells in a fuel cell stack.

An advantageous development of the method provides that at least the side to be coated of the bipolar plate has at least one elevation and at least one depression in the direction of a normal vector pointing away from the bipolar plate, wherein the elevation is hydrophilized at least in portions and the depression remains in its untreated surface state at least in portions. As mentioned above, bipolar plates are often provided with flow profiles for the targeted conveyance of gases and liquids. By hydrophilizing elevations directed away from the bipolar plate while depressions extending into the bipolar plate remain in their hydrophobic state, the fluid-guiding properties of the bipolar plate can be improved even further. Liquid thus remains on the elevations of the bipolar plate, wherein these elevations typically form a contact surface with a gas diffusion layer. On the one hand, this improves electrical conductivity with respect to the gas diffusion layer and a drainage effect for discharging product water that is produced.

According to a further advantageous embodiment of the method, an epoxy resin that can be cured by UV radiation is used, wherein the die is transparent to UV radiation at least in regions and the epoxy resin-carbon mixture is cured by irradiation with UV radiation when the die is placed on the coated side of the bipolar plate. In general, typical methods can be used to cure the epoxy resin-carbon mixture, such as adding a curing agent. However, since the curing of the epoxy resin-carbon mixture is realized by exposure to UV radiation, the step of admixing the curing agent can be omitted. With the help of the die, it is also possible to set a targeted layer thickness on the bipolar plate. For this purpose, the die can be set at the fixed distance from the bipolar plate. For example, such a layer thickness or the distance between the die and the bipolar plate can be 100 μm. However, thicker or thinner layers are also employable. The die remains on the bipolar plate while the epoxy resin is curing and thus protects the epoxy resin-carbon mixture, which is still soft, from damage and/or contamination. The die can be designed in such a way that it consists entirely of a material that is permeable to UV radiation, or the die can have individual recesses that are permeable to UV radiation. In particular, these recesses coincide with surface regions of the bipolar plate to which the epoxy resin-carbon mixture for coating the bipolar plate was applied. Ideally, an entire surface of at least one side of the bipolar plate is coated.

To fix the die on the bipolar plate, the bipolar plate and the die can remain in a common pressing machine during the curing process. However, the die can also be fixed on the bipolar plate, for example with the aid of at least one fixing element such as a screw, a clamp, a rubber, or the like. This allows the bipolar plate with the fixed die to be removed from a pressing machine and transported away. Spacers can also be inserted between the bipolar plate and the die in order to ensure the fixed distance between the bipolar plate and the die during the removal and transport of the bipolar plate and the die from a corresponding machine.

A further advantageous embodiment of the method also provides that for the application of the epoxy resin-carbon mixture on the side to be coated of the bipolar plate, the epoxy resin-carbon mixture is sprayed or brushed onto the side to be coated, in particular brushed on using a squeegee. This ensures a particularly uniform and seamless coating of the side to be coated of the bipolar plate. The epoxy resin-carbon mixture can be applied to the bipolar plate like a paint. By means of the squeegee, excess epoxy resin-carbon mixture accumulations can also be scraped off.

The cured epoxy resin-carbon mixture is preferably roughened by irradiation with a laser beam or with an abrasive beam, in particular a glass bead beam. The roughening of individual regions of the coating of the bipolar plate serves to prepare for the subsequent hydrophilization. Typically, individual regions of the coating with a height of approx. 5 to 20 μm are removed. Furthermore, it is sufficient that only the regions to be hydrophilized are partially roughened for adequate preparation for hydrophilization. With the help of a laser beam, the coating can be roughened in a particularly targeted and reliable manner. This is also possible using a glass bead beam. In general, however, the roughening can also be carried out by means of conventional abrasive blasting.

According to the invention, a bipolar plate has at least one coating in regions on at least one side to be coated, wherein a first portion of the coating has hydrophilic properties and a second portion of the coating has hydrophobic properties. By having individual coating portions with hydrophilic and hydrophobic properties, a moisture distribution on the bipolar plate according to the invention can be set in a targeted manner, which enables an increase in the performance of a fuel cell or a fuel cell stack with such a bipolar plate. In particular, the hydrophilic regions of the coating are applied to elevations of the bipolar plate and the hydrophobic regions of the coating are applied to depressions in the bipolar plate.

The coating of at least regions of the bipolar plate preferably takes place with an epoxy resin-carbon mixture, wherein the epoxy resin-carbon mixture has been applied to the bipolar plate using a method described above. A particularly reliable, simple and cost-effective coating of bipolar plates is possible with the help of such a method.

According to the invention, a fuel cell has at least one such bipolar plate. Because of the improved liquid removal properties of the bipolar plate and the improved electrical conductivity at the contact surface of the bipolar plate to a gas diffusion layer, an electrical power output by the fuel cell can be increased as a result.

According to the invention, a vehicle has at least one such fuel cell. Moreover, a plurality of such fuel cells can be combined to form a fuel cell stack. The vehicle can be any vehicle such as a car, truck, van, bus or the like. The vehicle can be designed as a hybrid vehicle with an internal combustion engine and at least one electric motor for driving the vehicle. The vehicle can also have a purely electrical drive. In general, it is also conceivable for the vehicle to be a rail vehicle, an aircraft or a ship.

Further advantageous embodiments of the method according to the invention and of the bipolar plate according to the invention result from the exemplary embodiments, which are described in more detail hereinafter with reference to the figures.

In particular:

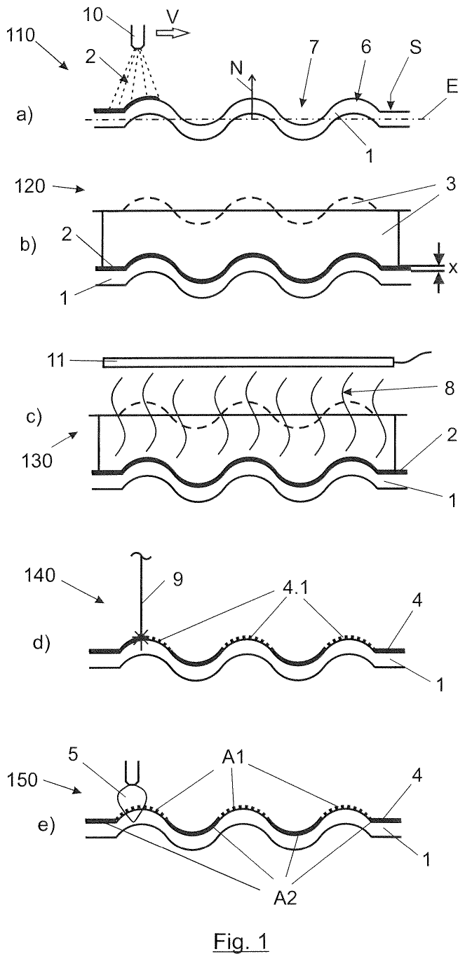

FIG. 1 shows a schematic representation of a method according to the invention for coating bipolar plates; and

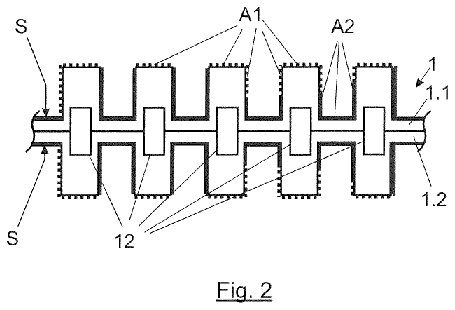

FIG. 2 shows a bipolar plate with an alternative geometry.

Portion a) of FIG. 1 shows a bipolar plate 1 which is coated with an epoxy resin-carbon mixture 2 in a step 110. The epoxy resin-carbon mixture 2 is applied with the aid of a nozzle 10 to a side S to be coated of the bipolar plate 1. In order to coat the bipolar plate 1, the nozzle 10 is moved along the bipolar plate 1 in a feed direction V. In general, it is also conceivable for the bipolar plate 1 to be moved relative to a stationary nozzle or a movable nozzle 10.

The bipolar plate 1 has a plurality of elevations 6 and depressions 7 extending in the direction of a normal vector N extending away from a plate plane E. The elevations 6 and depressions 7 form channels for conducting gases and/or liquids.

It is also possible, while not shown here, for the epoxy resin-carbon mixture 2 to be brushed onto the bipolar plate 1, for example by using a squeegee.

FIG. 1b) shows a step 120, in which a die 3 is placed on the bipolar plate 1 with a fixed distance x between the bipolar plate 1 and the die 3 in order to set a targeted coating thickness. In addition to setting the targeted layer thickness, the entire die 3 serves to protect a coating 4 that forms on the bipolar plate 1 as a result of the curing of the epoxy resin-carbon mixture 2 during the curing process. The die 3 can have any desired shape, wherein the die 3 has a shape matching the bipolar plate 1 on a side facing the side S to be coated of the bipolar plate 1. On the opposite side of the die 3, the die 3 can have a flat shape, for example, as indicated by a solid line, or can also have a shape that matches the bipolar plate 1, as indicated by the dashed line.

FIG. 1c) shows a step 130 in which the epoxy resin-carbon mixture 2 is cured. In the exemplary embodiment, the epoxy resin-carbon mixture 2 is cured by irradiating the epoxy resin-carbon mixture 2 with UV radiation 8. The UV radiation 8 can be generated by a UV lamp 11, for example. The die 3 is at least partially or completely transparent to UV radiation 8 so that the UV radiation 8 can travel through the die 3 and impinge on the epoxy resin-carbon mixture 2.

FIG. 1d) shows in step 140 a roughening of partial regions of the coating 4 formed by curing of the epoxy resin-carbon mixture 2 on the bipolar plate 1. For this purpose, partial regions of the coating 4 are treated with the aid of a laser beam 9. Instead of the laser beam 9, the roughened regions 4.1 can also be roughened with the help of an abrasive beam, not shown, for example by means of a glass bead beam.

FIG. 1e) shows step 150, in which a surface treatment of the roughened regions 4.1 with a low-pressure plasma 5 is shown. The low-pressure plasma 5 causes a transformation of a chemical structure of the coating 4, as a result of which polar functional groups are incorporated into it, whereby the regions of the coating 4 treated with the low-pressure plasma 5 are rendered hydrophilic. The roughened regions 4.1 are treated with the low-pressure plasma. The regions different from the roughened regions 4.1 remain untreated, as a result of which they have hydrophobic properties. Ideally, the elevations 6 are rendered hydrophilic, at least in some regions, and the depressions 7 remain in their untreated, hydrophobic state, at least in some regions. This allows a moisture distribution on the bipolar plate 1 to be adjusted in a targeted manner. In this way, liquid increasingly adheres to the elevations 6, which improves the electrical conductivity of the corresponding locations. It is difficult for liquid, in particular water, to collect in the depressions 7, which means that no ice can form in the depressions 7, for example at temperatures below freezing. A reliable removal of reaction liquid from the individual fuel cells of a fuel cell stack is thus ensured. In addition to increased electrical power, a corresponding fuel cell or a corresponding fuel cell stack can therefore also be operated reliably.

FIG. 2 shows a bipolar plate 1 according to the invention with an alternative geometry. In this case, the bipolar plate 1 can, for example, also have cooling channels 12 for guiding a cooling medium. FIG. 2 serves to illustrate that, in general, the bipolar plate 1 can have any desired plate-shaped geometry. In particular, elevations 6 and depressions 7 extend away from and into the bipolar plate 1, respectively. In the example in FIG. 2, the elevations 6 and depressions 7, respectively, are rectangular. In general, the elevations and/or depressions 6, 7 can have any geometry. For example, they can have a triangular, elliptical, circular or any polygonal cross-sectional shape. The elevations 6 and depressions 7 can also be of different sizes. It is particularly advantageous that a first portion A1, which has hydrophilic properties, is provided at least on a partial region of the elevations 6 and a second portion A2, which has hydrophobic properties, is provided at least partially on or in the depressions 7. The individual portions A1 and A2 can be configured individually on each elevation 6 and/or in each depression 7, namely they may have a different extent.

It is also possible for the bipolar plate 1 to be coated at least in portions on at least two opposite sides S.

Typically, the bipolar plate 1 is made from two separate bipolar plate halves 1.1 and 1.2, in that the bipolar plate halves 1.1 and 1.2 are connected to one another on their respective sides facing away from the elevations 6 and the depressions 7. The sides with the elevations 6 and depressions 7 form an anode side and a cathode side on which the coating is applied. Recesses for forming the cooling channels 12 can be introduced on the sides on which the bipolar plate halves 1.1 and 1.2 are connected.

What is claimed is:

1. A method for coating bipolar plates,
characterized by at least the following steps:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture, and removing the die;
roughening at least regions of the cured epoxy resin-carbon mixture coating;
hydrophilizing at least the roughened regions of the epoxy resin-carbon mixture coating by exposing at least the roughened regions to a low-pressure plasma.

2. The method of claim 1,
wherein
at least the side of the bipolar plate to be coated has at least one elevation and at least one depression in the direction of a normal vector pointing away from the bipolar plate, wherein the elevation is hydrophilized at least in portions and the depression remains in its untreated surface state at least in portions.

3. The method of claim 1,
wherein
an epoxy resin which can be cured by UV radiation used, the die is transparent to UV radiation at least in regions and the epoxy resin-carbon mixture is cured by irradiation with UV radiation with the die placed on the coated side of the bipolar plate.

4. The method of claim 1,
wherein
to apply the epoxy resin-carbon mixture on the side of the bipolar plate to be coated, the epoxy resin-carbon mixture is sprayed or brushed onto the side to be coated, in particular brushed on by using a squeegee.

5. The method of claim 1,
wherein
the cured epoxy resin-carbon mixture is roughened by irradiation with a laser beam or with an abrasive beam, in particular a glass bead beam.

6. A bipolar plate,
characterized by
a coating, at least in regions, with an epoxy resin-carbon mixture (2), of at least one side to be coated, wherein a first portion of the coating has hydrophilic properties and a second portion of the coating has hydrophobic properties.

7. The bipolar plate of claim 6,
characterized by
the epoxy resin-carbon mixture has been applied using a method comprising:
applying an epoxy resin-carbon mixture at least to regions of at least one side that is to be coated of a bipolar plate;
placing a die on to the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma.

8. A fuel cell,
characterized by
at least one bipolar plate of claim 7.

9. A vehicle,
characterized by,
at least one fuel cell of claim 8.

10. The method of claim 2,
wherein
an epoxy resin which can be cured by UV radiation is used, the die is transparent to UV radiation at least in regions and the epoxy resin-carbon mixture is cured by irradiation with UV radiation with the die placed on the coated side of the bipolar plate.

11. The method of claim 2,
wherein
to apply the epoxy resin-carbon mixture on the side of the bipolar plate to be coated, the epoxy resin-carbon mixture is sprayed or brushed onto the side to be coated, in particular brushed on by using a squeegee.

12. The method of claim 3,
wherein
to apply the epoxy resin-carbon mixture on the side of the bipolar plate to be coated, the epoxy resin-carbon mixture is sprayed or brushed onto the side to be coated, in particular brushed on by using a squeegee.

13. The method of claim 2,
wherein
the cured epoxy resin-carbon mixture is roughened by irradiation with a laser beam or with an abrasive beam, in particular a glass bead beam.

14. The method of claim 3,
wherein
the cured epoxy resin-carbon mixture is roughened by irradiation with a laser beam or with an abrasive beam, in particular a glass bead beam.

15. The method of claim 4,
wherein
the cured epoxy resin-carbon mixture is roughened by irradiation with a laser beam or with an abrasive beam, in particular a glass bead beam.

16. The bipolar plate of claim 6,
characterized by
the epoxy resin-carbon mixture has been applied using a method comprising:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma, wherein
an epoxy resin which can be cured by UV radiation is used, the die is transparent to UV radiation at least in regions and the epoxy resin-carbon mixture is cured by irradiation with UV radiation with the die placed on the coated side of the bipolar plate.

17. The bipolar plate of claim 6,
characterized by
the the epoxy resin-carbon mixture has been applied using a method comprising:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma, wherein
at least the side of the bipolar plate to be coated has at least one elevation and at least one depression in the direction of a normal vector pointing away from the bipolar plate, wherein the elevation is hydrophilized at least in portions and the depression remains in its untreated surface state at least in portions.

18. The bipolar plate of claim 6,
characterized by
the the epoxy resin-carbon mixture has been applied using a method comprising:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma, wherein to apply the epoxy resin-carbon mixture on the side of the bipolar plate to be coated, the epoxy resin-carbon mixture is sprayed or brushed onto the side to be coated, in particular brushed on by using a squeegee.

19. The bipolar plate of claim 6,
characterized by
the the epoxy resin-carbon mixture has been applied using a method comprising:
applying an epoxy resin-carbon mixture at least to regions of at least one side that is to be coated of a bipolar plate;
placing a die onto the side coated with epoxy resin-carbon mixture of the bipolar plate and fixing the die relative to the bipolar plate with a fixed distance between bipolar plate and die;
curing the epoxy resin-carbon mixture and removing the die;
roughening at least regions of the cured epoxy resin-carbon mixture coating;
hydrophilizing at least the roughened regions of the epoxy resin-carbon mixture coating by exposing at least the roughened regions to a low-pressure plasma, wherein the cured epoxy resin-carbon mixture is roughened by irradiation with a laser beam or with an abrasive beam, in particular a glass bead beam.
